(19) United States
(12) Patent Application Publication
(10) Pub. No.: US 2005/0226439 A1
(43) Pub. Date: Oct. 13, 2005

(54) Noise cancellation using virtually lossless sensing method

(76) Inventor: Christopher Ludeman, Palm Bay, FL (US)

Correspondence Address: AKERMAN SENTERFITT, P.O. BOX 3188, WEST PALM BEACH, FL, 33402-3188, US

(21) Appl. No.: 10/851,597

(22) Filed: May 21, 2004

Related U.S. Application Data
(60) Provisional application No. 60/561,373, filed on Apr. 9, 2004.

(51) Int. Cl. H04R 3/00; H04R 29/00

(52) U.S. Cl. 381/96; 381/59

(57) ABSTRACT

An active noise cancellation system includes at least one amplifier, and a speaker driven by the amplifier. The speaker comprises a speaker coil and a spaced apart speaker magnet mounted on a diaphragm. The speaker current in the speaker coil comprises a signal originating from a signal source and an ambient induced back current noise signal. The amplifier virtually losslessly senses the speaker current without the need for inherently lossy sensing resistors. A feedback circuit receives the speaker current sensed and output by the amplifier and provides a feedback signal comprising a modified version of the noise signal to a summing point, wherein the feedback signal and the signal from the signal source are mixed. The summing point is coupled to an input of the amplifier. By adding the feedback signal in the correct anti-phase to the signal from the signal source, the noise in the vicinity of the ear/speaker is virtually eliminated.

### CROSS-REFERENCE TO RELATED APPLICATIONS

This application claims the benefit of Provisional Application No. 60/561,373, filed on Apr. 9, 2004, which is incorporated by reference in its entirety in the present application.

### STATEMENT REGARDING FEDERALLY SPONSORED RESEARCH OR DEVELOPMENT

Not applicable.

### FIELD OF THE INVENTION

The present invention relates to active noise cancellation systems, and more particularly, to headsets utilizing active noise cancellation.

### BACKGROUND OF THE INVENTION

Conventionally, passive headsets and over-the-ear earplugs include a pair of earpieces coupled by a resilient headband. An annular foam pad attached to each earpiece forms a cushion between the shell of the earpiece and the user's head. The resilient headband presses the earpieces against the head of the user. Ambient sound is attenuated before it reaches the wearer's ear by occlusion of sound by the earpieces and absorption of transmitted sound by materials within the earpieces. The degree of attenuation achieved depends upon the nature of the ambient noise and the qualities and characteristics of the individual headset or earplugs.

In a variety of applications, passive attenuation is insufficient. Some environments are simply too noisy for comfort or even safety with only passive earplugs. In other environments, the elimination of extraneous noise is essential, and satisfactory results cannot be achieved using passive means. Although the amplitude of the extraneous noise may be significantly diminished, it is almost impossible to completely isolate the wearer from extraneous noise using passive means.

Active noise cancellation systems eliminate unwanted sound using destructive interference. Cancellation is achieved by propagating anti-noise, identical to the unwanted sound waves but inverted in phase, which interacts with the unwanted sound waves and results in cancellation. A feedback active cancellation headset typically includes a sound generator in each earpiece for producing anti-noise, and a residual microphone, either inside or outside the headphone enclosure, to provide feedback signals to a controller which generates the proper anti-noise signals. The microphone detects the unwanted noise within each earpiece and provides a corresponding signal to the controller. The controller supplies anti-noise signals to the sound generator corresponding to the noise detected in the earpieces, but inverted, with respect to the unwanted waveform. When the anti-noise interacts with the noise within each earpiece, destructive interference between the noise and the anti-noise partially cancels the unwanted sound.

For example, U.S. Pat. No. 2,972,018 to by Hawley et al. (1953) provide a microphone which responds to ambient noise and a speaker which transmits an altered version of the ambient noise to provide a measure of noise cancellation in the region of the microphone. Virtually all subsequent patents or improvement incorporate some variant of this concept, thus including a dedicated microphone in the noise cancellation circuit.

### SUMMARY OF THE INVENTION

The invention provides active noise cancellation systems which use a novel sensing scheme for applications including headphone speakers. An active noise cancellation system includes at least one amplifier, and a speaker driven by the amplifier. The speaker comprises a speaker coil and a spaced apart speaker magnet mounted on a diaphragm. The speaker current in the speaker coil comprises a signal originating from a signal source and an ambient induced back current noise signal.

The amplifier virtually losslessly senses the speaker current as compared to conventional approaches which utilize inherently lossy sensing resistors. Series sensing resistors can substantially reduce the level of the signal to be manipulated for noise cancellation. As used herein, the phrase “virtually lossless sensing” refers to sensing the speaker current including thee back current noise signal without using a conventional series sensing resistor. In one embodiment, the amplifier can be a transconductance amplifier which senses the speaker current including the back current noise signal. The transconductance amplifier preferably uses a current mirror arrangement.

A feedback circuit receives the speaker current sensed and output by the amplifier and provides a feedback signal comprising a modified version of the noise signal to a summing point, wherein the feedback signal and the signal from the signal source are mixed. The summing point is coupled to an input of the amplifier. By adding the feedback signal in the correct anti-phase to the signal from the signal source, the noise in the vicinity of the ear/speaker is virtually eliminated.

### BRIEF DESCRIPTION OF THE DRAWINGS

A fuller understanding of the present invention and the features and benefits thereof will be accomplished upon review of the following detailed description together with the accompanying drawings, in which:

FIG. 1 is a functional block diagram of an embodiment of an active noise cancellation system according to an embodiment of the invention.

FIG. 2 shows an exemplary amplifier circuit for the virtually lossless sensing of the current signal from the speaker coil when used as a microphone in system shown in FIG. 1.

FIG. 3 shows an active noise cancellation system which includes a specific exemplary transfer block embodiment having calibration circuitry for canceling signal echo shown while in the normal operational (non-calibration) position, according to an embodiment of the invention.

FIG. 4 shows the an active noise cancellation system with exemplary transfer block shown in FIG. 3 while in the calibrate position.

### DETAILED DESCRIPTION

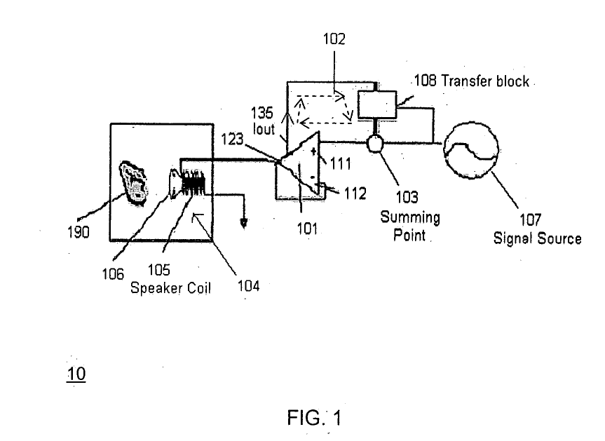

Referring to FIG. 1, an embodiment of the invention is shown. An active noise cancellation system 10 includes a signal amplifier 101 and a speaker 104, such as a headphone speaker, which is driven by the amplifier 101. The amplifier 161 includes inverting input 112, non-inverting input 111, output 123, and sensed current output (I_{OUT}) 135. Although amplifier 101 is shown in FIG. 1 configured as a unity gain buffer, the invention is in no way limited to this arrangement.

Amplifier 101 also senses the ambient induced noise current (along with the signal source current) in the speaker coil 105. Speaker 104 includes a speaker coil 105, and speaker magnet (not shown) mounted on a diaphragm 106 for generating sound waves detectable by the ear of a listener 190. The speaker 104 is disposed proximate to the ear of the listener 190 so that the noise waves reaching the speaker 104 and sensed by coil 105 are virtually the same the noise waves reaching the ear of the listener 190.

Amplifier 101 is part of a feedback loop 102 that includes transfer block 108 which provides a feedback signal including the sensed noise signal to a summing point 103. In a preferred embodiment, amplifier 101, the components comprising transfer block 108, such as one or more amplifiers, switches, attenuators and filters, and the summer represented as summing point 103, are all disposed on a single semiconductor chip, such as a Si chip. In inventive embodiments which include digital signal processor(s), the digital signal processor may be disposed on the same chip, or a separate chip.

Although one signal amplifier 101 is included in system 10 shown in FIG. 1, a bridge tied load arrangement (not shown) may also be used where signal amplifier 101 is actually two (2) amplifiers. In a bridge tied load arrangement, the respective amplifiers are operated in anti-phase, with each amplifier driving one end of speaker coil 105.

The speaker coil 105 has a bi-directional transfer function. Sound waves arriving from outside, and terminating on the speaker diaphragm 106, generate back currents in coil 105. In conventional systems, the back current is terminated into a low impedance at the amplifier output(s) and information related to the magnitude and frequency of these back currents is lost as a result. However, the current in coil 105 comprising the ambient induced back current noise signal is instead processed by system 10 (together with the signal originating from signal source 107 flowing in coil 105 which is generally in the same band as the noise). This arrangement thus recovers the back current information, and system 10 uses it to cancel the noise that generated it.

Signal source 107 can be any signal source, such as from a compact disk (CD) or MP3 player. The signal from signal source 107 is fed to the headphone speaker 104 by way of amplifier 101. Signal source 107 is also shown connected to transfer block 108.

As noted above, amplifier 101 senses the current (signal source generated plus back-current noise generated) in the speaker coil 105. Although amplifier 101 is used for current sensing, other virtually lossless sensing arrangements are possible. For example, a transformer arrangement can be used where an additional coil (not shown) can be wrapped around coil 105 to sense the current in coil.

The current sensed by amplifier 101 is injected into a feedback circuit loop 102 which comprises transfer block 108. Transfer block 108 includes one or more filters, switches, attenuators and/or amplifiers. Specifically, the signal originating from signal source 107 and the ambient induced back current noise signal are processed by transfer block 108 to produce the ambient back current noise component, or a modified version thereof, which is then added at summing point 103 to the signal provided by signal source 107. If desirable, transfer block 108 can be designed to pass certain desired frequency bands. For example, it may be desirable to provide only low pass filtering to pass certain relatively high audio frequency bands, such as to permit the ring of a cell phone to reach the listener. Thus, the noise signal can be amplified if desired, filtered to the user requirements, and added into the signal path.

However, as a practical matter, the noise signal may be much lower in amplitude as compared to the signal from the source signal 107, depending on the ambient conditions. Because amplifier 101 senses both the signal and ambient induced back current simultaneously, it is generally advantageous to partially cancel some of the signal from source signal 107 to prevent overloading the circuit elements comprising transfer block 108. There are several well-known techniques to accomplish this.

As noted above, the signal from the signal source 107 is summed with the processed noise signal output by transfer block 108 at summing point 103. Summing point 103 shown in FIG. 1 is coupled to the non-inverting input 111 of amplifier 101. Thus, the modified noise signal together with the signal from the source signal 107 drive speaker 104. By adding the modified noise signal having the correct anti-phase to the signal from the signal source, the noise in the vicinity of the ear 190 is thus virtually eliminated.

In a preferred embodiment of the invention, amplifier 101 is based on transconductance amplifier circuits described in U.S. Pat. No. 6,411,163 to Enriquez (hereafter “Enriquez '163”). Enriquez '163 is hereby incorporated by reference in its entirety into the current application. Enriquez '163 discloses a transconductance amplifier circuit, which transforms a single ended input voltage into a precise, single ended output current, in a manner that is effectively independent of respective voltage supply rails, and which can be operated at a very low quiescent current. The operational amplifier is configured as a unity gain buffer whose output stage is coupled in circuit with first current flow paths of first and second current mirrors. A single ended output of the output stage serves as an input terminal and is coupled via a negative feedback path to a first, inverting input of the operational amplifier. Second current flow paths of the pair of current mirrors are coupled to an output port, which supplies an output current linearly proportional to the composite input voltage applied to the input terminal. As used in the present invention, the transconductance amplifier circuits disclosed by Enriquez '163 provide virtually lossless sensing of the current signal from the speaker used as a microphone in the current invention.

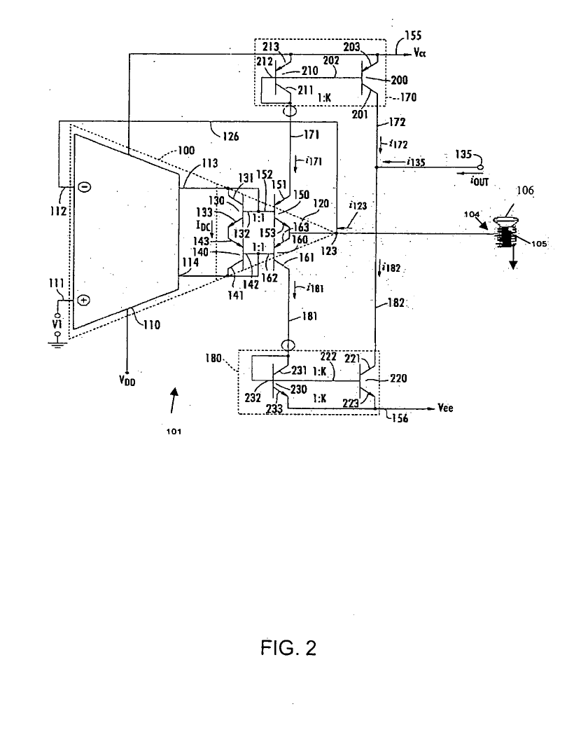

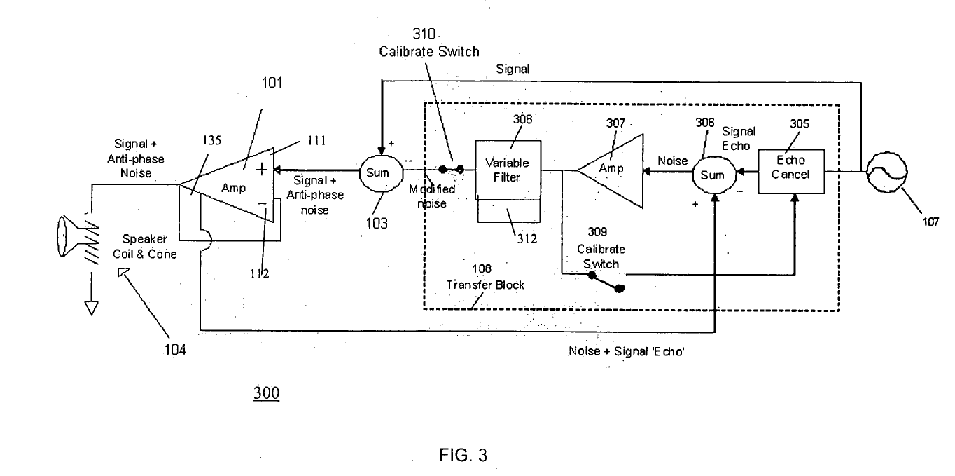

FIG. 2 shows an exemplary amplifier circuit 101 adapted from FIG. 3 of Enriquez '163 for the virtually lossless sensing of the current signal from the speaker coil 105 when used as a microphone in system 10 shown in FIG. 1. Amplifier references in FIG. 2 track those which are shown in FIG. 1. Descriptions for other references shown in FIG. 2 may be found in Enriquez '163. Speaker coil 105 is shown connected between the output of amplifier 123 and ground. In this arrangement, the speaker current i₁₂₃ is sensed by amplifier 101 which provides an output current 135 for further processing in feedback loop 102 shown in FIG. 1. Although not shown in FIG. 2, a bridge tied load arrangement may also be used where signal amplifier 101 is actually two (2) amplifiers which provide balanced driving to speaker 104.

Signal “echo” of the signal from signal source 107 generally results as a consequence of the sensing method disclosed herein because the current in coil 105 includes both the back current noise signal and the forward signal from the signal source 107. FIG. 3 shows an active noise cancellation system 300 which includes a specific exemplary transfer block 108 embodiment having calibration circuitry for minimizing signal echo according to an embodiment of the invention. System 300 is shown in FIG. 3 while in the normal operational (non-calibrate) position.

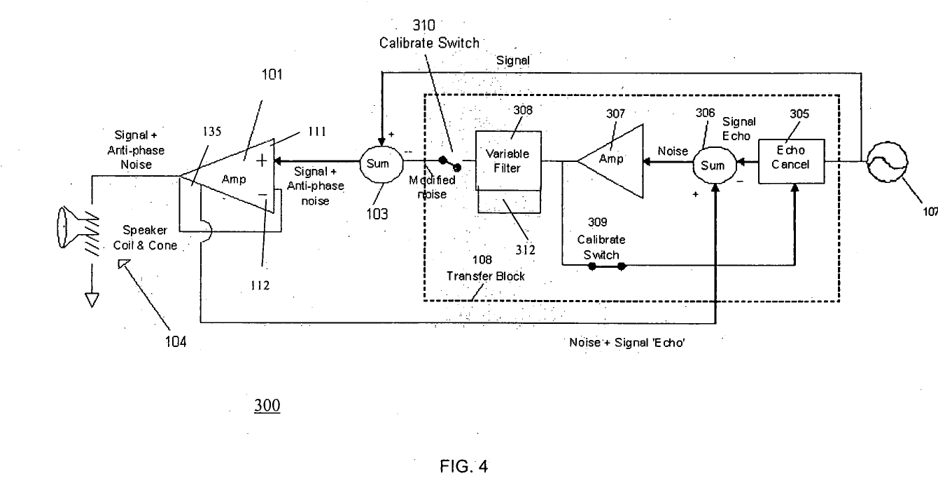

Transfer block 108 shown in FIG.3 includes echo canceller 305, summer 306, amplifier 307, variable filter 308, and calibrate switches 309 and 310. In the operational (non-calibrate) mode shown in FIG. 3, switch 309 is open while switch 310 is closed. When closed during calibration (shown in FIG. 4), switch 309 feeds back the signal at the output of amplifier 307 to echo canceller 305.

Amplifier 101 virtually losslessly senses and provides a feedback signal comprising the sensed back current noise signal and signal echo from signal source 107 to summer 306. Summer 306 can be an amplifier or other device capable of summing signals.

Echo canceller 305 is driven by signal source 107. Echo canceller is preferably a filter which has a frequency response which treats different frequencies differently. Although shown in FIG. 3 as an analog filter, echo canceller can be embodied as a digital filter. The output of echo canceller 305 drives summer 306. The echo canceller 305 includes circuitry for minimizing the residual signal echo signal. In one embodiment, echo canceller 305 is an adaptive filter which continuously adjusts the transfer function of echo canceller to minimize the residual echo using known algorithms, such as using least mean squares.

Although not shown, in an alternate embodiment of the invention, echo canceller 305 can also approximate the transfer function needed to cancel the signal echo, and thus not need to be adaptive or calibrated. This alternate embodiment can be used to simplify transfer block 108 shown in system 300, allowing removal of switches 309 and 310.

Following the calibration described relative to FIG. 4, the output provided by echo canceller 305 closely matches the signal echo provide by amplifier 101. As a result, the output of summer 306 is the noise signal alone. Amplifier 307 receives the noise signal output by summer 306. Variable filter 308 can shape the noise signal, such as allowing certain bands (e.g. cellular phone ring) to pass and blocking certain bands (e.g. low frequency bands). An optional user selectable switch 312 permits such a selection.

The output from variable filter 308 comprising the modified noise is then summed with the signal from signal source 107 at summer 103. Summer can be a unity gain operational amplifier where the modified noise signal is connected to its inverting input and the signal from the signal source 107 is connected to its non-inverting input. As a result, the signal output by summer 103 provided to amplifier 101 comprises the signal from the signal source 107 together with the modified anti-phase noise signal.

FIG. 4 shows the active noise cancellation system 300 with exemplary transfer block 108 shown in FIG. 3 while in the calibrate position. In this state, switch 309 is closed while switch 310 is open. Thus the output of amplifier 307 is fed back to echo canceller 305. The transfer function of echo canceller 305 is tuned so that its output matches the signal echo provided by amplifier 101 at its current output (I_{OUT}) 135. Thus, the signal output by summer 306 closely matches the noise single and does not include any appreciable signal from the signal source 107. Generally, calibration of echo canceling filter 305 is performed before sale of noise canceling speaker systems according to the invention, such as using a swept frequency sound source to tune the frequency response of echo canceling filter 305.

The invention can be applied to a variety of headphone types. One type is earcup-type headphones. However, the invention is particularly useful for headphones that are in-ear and non-sealed types, where there is little room to fit a separate microphone and power source.

It is to be understood that while the invention has been described in conjunction with the preferred specific embodiments thereof, that the foregoing description is intended to illustrate and not limit the scope of the invention. Other aspects, advantages and modifications within the scope of the invention will be apparent to those skilled in the art to which the invention pertains.

1. An active noise cancellation system, comprising:
at least one amplifier;
a speaker driven by said amplifier, said speaker comprising a speaker coil and a spaced apart speaker magnet mounted on a diaphragm, said speaker generating sound waves detectable by a listener, wherein a speaker current in said speaker coil comprises a signal originating from a signal source and a back current noise signal, said amplifier virtually losslessly sensing and outputting said speaker current, and
a feedback circuit for receiving said speaker current output by said amplifier, said feedback circuit providing a feedback signal comprising a modified version of said noise signal to a summing point, wherein said feedback signal and said signal from said signal source are mixed at said summing point, said summing point coupled to an input of said amplifier.

2. The system of claim 1, wherein said amplifier comprises a transconductance amplifier.

3. The system of claim 2, wherein said transconductance amplifier includes at least one current mirror, said current mirror providing said virtually lossless sensing of said speaker current.

4. The system of claim 1, wherein said feedback circuit includes an echo canceling filter, said echo canceling filter approximating a transfer function to cancel said signal originating from said signal source.

5. The system of claim 4, wherein said echo canceling filter is an adaptive filter.

6. The system of claim 5, wherein said feedback circuit further comprising an echo summer, said echo summer receiving outputs from said echo canceling filter and said speaker current output by said amplifier.

7. The system of claim 6, wherein an output of said echo summer is provided to an input of a feedback loop amplifier.

8. The system of claim 7, wherein said feedback circuit includes at least one switch for initiating calibration of said circuit, said switch connecting an output of said feedback amplifier to said echo canceling filter, wherein during calibration said echo canceling filter is adaptively modified to approximate a transfer function to cancel said signal originating from said signal source.

9. The system of claim 7, further comprising a tunable filter connected to an output of said feedback loop amplifier.

10. The system of claim 9, wherein said tunable filter includes a user operable switch for selecting at least one pass band.

11. A method of canceling noise, comprising the steps of:
virtually losslessly sensing a current in a speaker coil, said current comprising a signal originating from a signal source and a back current noise signal;
processing said current to generate an anti-sense signal relative to said back current noise signal, and
injecting said anti-sense signal into a signal path which transmits a signal from said signal source to a listener, said anti-sense signal canceling said back current noise signal for said listener.

12. The method of claim 11, wherein said processing step comprises adaptively canceling said signal from said signal source.

13. The method of claim 12, wherein said adaptively canceling step comprises switching into a calibrate mode, wherein a transfer function of calibrating circuitry is adaptively modified to improve cancellation of said signal originating from said signal source.
